(19) United States
(12) Patent Application Publication
(10) Pub. No.: US 2015/0103401 A1
(43) Pub. Date: Apr. 16, 2015

(54) REFERENCE COLOR SLIDE FOR USE IN COLOR CORRECTION OF TRANSMISSION-MICROSCOPE SLIDES

(71) Applicant: Datacolor Holding AG, Luzern (CH)

(72) Inventors: Tae-Young Park, Princeton Jct., NJ (US); Hong Wei, Princeton, NJ (US)

(73) Assignee: Datacolor Holding AG, Luzern (CH)

(21) Appl. No.: 14/183,885

(22) Filed: Feb. 19, 2014

Related U.S. Application Data
(60) Provisional application No. 61/889,720, filed on Oct. 11, 2013.

(51) Int. Cl. G02B 21/34; G02B 21/36

(52) U.S. Cl. CPC G02B 21/34; G02B 21/365
USPC 359/363; 359/396

(57) ABSTRACT

The present invention is a microscope slide apparatus and method of use thereof, wherein the slide has an integrated color calibration array of filter elements, each element having a given dimension, each element also having a known transmission spectrum. The complete filter array is observable in the field of view of a microscope under at least one magnification setting of a microscope. The invention further characterized with a secondary integrated filter array that is completely observable at a second magnification setting.

### CROSS REFERENCE TO RELATED APPLICATION

The present application claims the benefit of U.S. patent application Ser. No. 61/889,720, filed Oct. 11, 2013, which is hereby incorporated by reference in its entirety.

### FIELD OF THE INVENTION

The present invention is directed to a microscope slide with an integrated color filter array used to assist in obtaining the proper color values necessary to color calibrate an image of a sample. The present invention is also directed to an integral color filter array equipped with sub-filter arrays such that a complete set of filter arrays is visible in a microscope field of view. The microscope slide with an integral color filter array is used in conjunction with an image analysis appliance to record the color values of the slide with an integrated color filter array and generate a suitable color calibration factor for use in calibrating an image taken under specific microscope settings. The color calibration factor is used to generate a new composite image of a sample having the correct color values when displayed to a user.

### BACKGROUND OF THE INVENTION

Currently, digital imaging has allowed for unprecedented levels of collaboration between technicians, researchers, and scientists. In part, this collaboration is due to the relatively inexpensive nature of current digital imaging technology. Image capture devices and associated software platforms combined with improved computer screens and monitors have also allowed for the rapid analysis and review of images where accurate color fidelity is essential. The proliferation of different styles, models and technical complexity of digital imaging technology can be readily seen in the digital microscopy market. In the field of digital imaging, there are many microscope systems that provide custom digital images. Unfortunately, there is no system or method currently available that ensures color accuracy and consistency from one system to another.

Additionally, recording images of hard to detail specimens requires diligence. A fortuitous imaging of a sample might not be replicable under subsequent conditions. However, once the image is recorded, modifying it in imagine editing suites can alter the desired appearance. Therefore, what is needed is the ability to calibrate an image of a sample so as to render the sample in different lighting conditions. In order to accurately modify the RGB values of a digital image, various data points regarding illumination and transmittance spectra need to be known beforehand. Thus, what is needed is a system and apparatus that incorporates the various illuminant data into a synthetic device-independent image which is modifiable given a desired illuminant type.

Commonly owned U.S. patent application Ser. No. 13/211,875 titled “System and Apparatus for the Calibration and Management of Color in Microscope Slides” filed on Aug. 17, 2011, which is hereby incorporated by reference in its entirety, describes the use of color calibrated slides to determine the color values of biological samples under various lighting conditions. However, the system described in the '875 application does not describe technical features particular to the presently described microscope slide with integrated color filter array.

Commonly owned U.S. patent application Ser. No. 13/856,727 titled “System and method for color correction of a microscope image with a built-in calibration slide”, filed on Apr. 4, 2013, which is hereby incorporated by reference in its entirety, describes the use of color calibrated slides to determine the color values of biological samples under various lighting conditions. However, the system described in the '727 application does not describe certain technical features particular to the presently described microscope slide with integrated color filter array.

Published article, “Color correction in whole slide digital pathology,” Proc. 20^{th} IS&T Color and Imaging conference, November, 2012, by Y. Murakami, H. Gunji, F. Kimura, A. Saito, T. Abe, M. Sakamoto, P. Bautista, and Y. Yagi, herein incorporated by reference in its entirety, likewise describes the use of color calibration slides. However the system described in the cited publication does not describe critical technical arrangements particular to the microscope slide of the present invention. For instance, the incorporated publication is limited to disclosing only nine colors in the slide. These nine miniature color films are arranged on a glass plate, and the colors were selected to include typical six colors (cyan, magenta, yellow, red, blue, and green) and the three colors often appeared in H&E stained tissue samples.

However, what is needed is a microscope slide that simplifies and standardizes the calibration of an image taken with a microscope or other imaging device. In particular, the present apparatus includes a microscope slide which incorporates an integrated color filter array. Furthermore, what is needed is an integrated filter array which is easily manufactured and incorporates small dimension interference filters. What is also needed is an apparatus and system directed to a microscope with an integrated color filter array with sub-filter array elements. The subject invention is addressed to these deficiencies in the art.

### SUMMARY OF THE INVENTION

In accordance with a broad aspect of the present invention a microscope slide with an integrated color filter element array is described for use in the calibration and analysis of images taken during a microscopy session. In more particular aspects, the present invention provides a microscope slide with an integrated color filter array in which a complete set of color filter elements is viewable at each of the different magnification/objective settings of a microscope.

The transmission spectra of the described integrated color filter array are used to generate a color modification or correction factor use to correct the color of images taken with a microscope and intended for display on a display device. In order for the color modification to be accurate, the filter array must be visible and recordable at any given microscope objective. As such the microscope slide apparatus described is equipped with a series of sub-filter elements which replicate all the color filter elements of the larger color filter element. In this manner, even after a 100× magnification, sufficient color filter elements are viewable or recordable from the microscope slide.

The system incorporating the microscope slide with integrated filter element also includes a microscope with known or controllable numerical aperture and magnification settings, an imaging device configured to output the RGB camera values to a processor system, and a processor system which is capable of generating linear or non-linear mapping of RGB to C.I.E. tristimulus XYZ values.

Additionally, the described microscope slide is useful in a series of steps for color correcting microscope samples. The steps includes calculating the CIE tristimulus values of the plurality of color elements of the slide array by using real or ideal illuminant spectral power distribution, known color filter transmission spectra values, and the 2° CIE color matching functions. A further step is provided for mapping the RGB pixel values of the color filter array to C.I.E. tristimulus values through a color mapping matrix. An additional step includes generating device-independent CIE tristimulus values for each pixel of the sample image through the application of the color mapping matrix. A final step is provided for outputting the CIE tristimulus image to a calibrated output device.

### BRIEF DESCRIPTION OF THE DRAWINGS

FIG. 1 is an illustrative diagram of the slide described herein inserted into a standard microscope apparatus.

FIG. 2 is an illustrative diagram of a microscope slide and integrated color filter array in accordance with one arrangement of the system.

FIG. 3 is an illustrative diagram of an integrated color calibration chip in accordance with one arrangement of the system.

FIG. 4 is a magnified view of the center of an integrated color calibration chip in accordance with one arrangement of the system.

FIG. 5A is an example of the interference filter spectra of the color calibration chip.

FIG. 5B is an example of the neutral density filter spectra of the color calibration chip.

FIG. 5C is a specification table listing the central wavelength, bandwidth, and transmission of the interference filter.

### DESCRIPTION OF ILLUSTRATIVE CERTAIN EMBODIMENTS OF THE INVENTION

By way of overview and introduction, the present invention concerns a microscope slide with an integrated color filter array. The color filter array further includes sufficient interference color filters and neutral filters to cover the general spectrum of colors encountered when imaging biological samples. Additionally, the color filter array incorporates sub-filter arrays at a smaller scale so that at each magnification level, a complete spectrum of color and interference filter elements is observable and recordable. Furthermore, the microscope slide described is directed to a system and method for providing sufficient color information in order to generate a color mapping matrix which allows for the creation of a synthetic image depicting the sample under a desired illuminate. The system and method allows for a technical solution to color correction that allows for the acquisition of an image of a sample, the color correction of the sample image, and the accurate display of the image across various display devices. The described microscope slide with integrated color filter array is a cost-effective solution to color calibration needs in the microscopy field.

There is a degree of color variation between biological samples viewed through a microscope and viewing images of those same samples on a display devise. Moreover, image analysis is affected by the color variation; indeed, most software requires manual instructions to compensate for color variation.

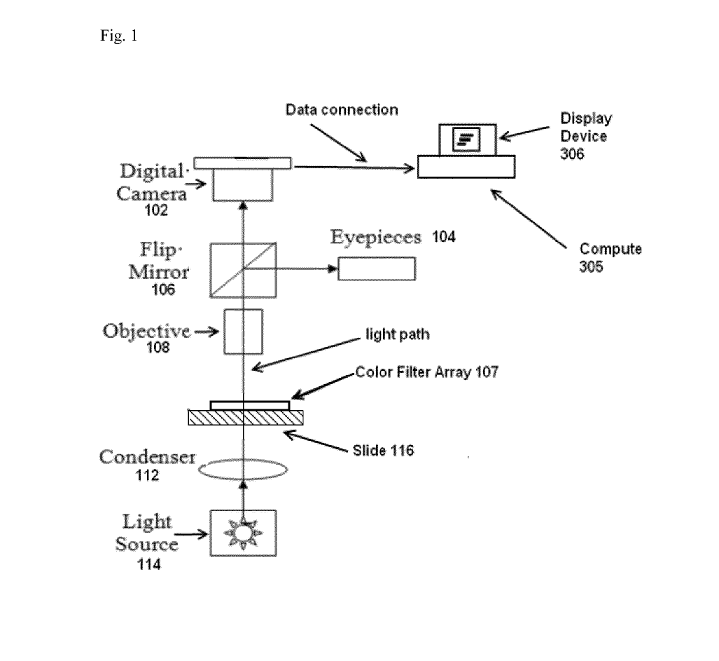

As seen in FIG. 1, the principles behind the microscope slide described are applicable to, and can be used in conjunction with, multiple types of microscopes. For example, the illustrated arrangement employs the use of a transmission microscope. However, those skilled in the art will recognize that the principles behind the described microscope slide allow for integration into different microscope types, such as reflectance or fluorescent microscopes.

A transmission microscope is a device or apparatus in which the light source and the viewer are on opposite sides of the plane of the slide/specimen, and in which transmitted light is passed through the specimen. The light is transmitted to an image recording device designed to record images of a sample. When using a transmission microscope, those images are the product of the incident illumination of the light source and the transmittance spectrum of the specimen. FIG. 1 illustrates an imaging device 102 configured to record images of a slide 116 in a transmission microscope. The light directed from the light source 114 is conditioned by the condenser 112 and illuminates the color filter array of the slide 116. The objective 108 collects the light (shown as a light path arrow) passing through the color filter array 107 and delivers that light to either the eyepiece 104 or imaging device 102, through a flip mirror 106. The imaging device 102 is configured to output the images to a processor, such as a computer 305. The computer 305 is optionally equipped with an output device 306, such as a calibrated monitor.

In the illustrated arrangement, the imaging device 102 is a CCD (Charged Coupled Detector) or CMOS (Complementary metal-oxide-semiconductor), having sufficient components to record images to a temporary or permanent storage device. In a specific arrangement, the CCD sensor of the imaging device 102 is a ⅓″ frame pixel recording device. Furthermore, the imaging device is configured to record images having at least three (3) independent color channels (tri-chromatic characteristics).

The imaging device 102 is also configured to transmit recorded images to the computer 305 for analysis or processing. Those skilled in the art will appreciate that the data connection between the imaging device 102 and the computer 305 is any standard wired or wireless connection. For example, the imaging device 102 and the computer 305 of FIG. 1 are connected via a data cable. However, in an alternative arrangement of elements, the data connection is supplied by a local area network (LAN) or short range wireless network using protocols such as Wi-Fi, Bluetooth, or RFID.

The imaging device 102 is any device capable of capturing the required spectral data in sufficient detail necessary for the calibration functions to proceed. For example, a digital still camera, digital motion picture camera, portable computer camera, desktop computer camera, PDA with equipped camera, imaging device equipped smart-phone, camera phone, web camera, and so on, having sufficient resolution for capturing color information, are suitable imaging devices. Likewise, any device may be used as an imaging device so long as it is capable of capturing optical data through a lens or plurality of lenses, and transmitting an image file that includes the captured data. As one non-limiting example, a digital single lens reflex camera and microscope adaptor is a suitable image capture device.

In the given arrangement, the light source 114 is an incandescent light source, such as a halogen-based light source. Further, the light source 114 is positioned such that the reference illuminations emitted by the light sources 114 are incident upon the microscope stage and the slide 116.

Those skilled in the art will appreciate that other light sources, so long as their spectral power distributions (SPD) cover the visible wavelength range, are suitable for use in the described system.

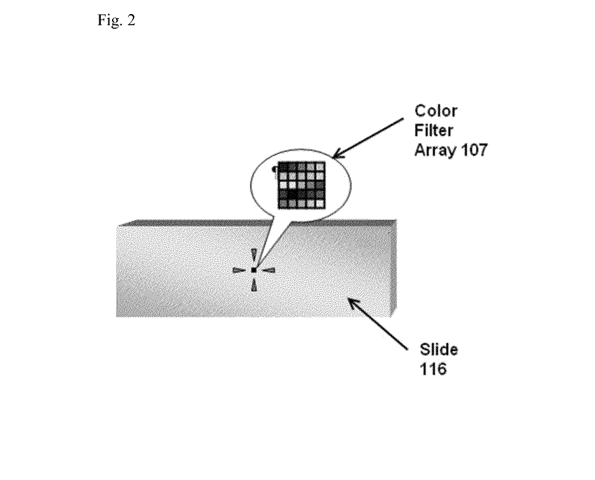

FIG. 2 illustrates a specimen slide 116 (slide substrate) containing a composite color filter array 107 of known interference color and neutral filters. The slide 116 is positioned such that the color filter array 107 is directly illuminated. In FIG. 2, the color filter array 107 is a grid. However, those skilled in the art will appreciate that other specific geometries of the color calibration arrays are envisioned.

In a further arrangement, the color filter array 107 contains a plurality of sections with different transmission spectra necessary to replicate the complete range of transmission spectra likely to appear in the slide image. In the one arrangement, at least one portion of the array contains neutral (black, white and grey) elements. Furthermore, while the color filter array 107 is depicted within the center of the slide 116, it is possible to position the color array at any position on the slide substrate that is visible to an imaging device 102.

The specific transmission characteristics (such as transmission percentage at each wavelength for a variety of settings of the microscope numerical aperture) of each element of the color filter array 107 is known and stored within a database accessible by the computer 305.

The slide substrate 116 is formed of standard optical slide materials that are commercially available for the given purpose. The slide substrate 116 is composed of any suitable material for inclusion with the given microscope type. For example, the slide substrate 116 is composed of glass, plastics, composite materials, and other standard transparent materials used for transmission microscopy slide production.

The slide 116 can be formed of material suitable for photolithography. Such photolithography based slides are composed of materials that are commonly used in the art for photolithography techniques. For example, the filter elements consist of multiple thin layers of dielectric material having different refractive indices. In one arrangement, photosensitive material is deposited on a slide substrate followed by a dielectric layer or a set of dielectrics. These materials are then etched to produce filter elements of the desired size. In the alternative, thermal oxidation is initially performed on a substrate of slide material and spectral properties (e.g. silicon) on its bottom face and on its top face. The substrate is covered with a layer of photosensitive resin. Thereafter, a desired geometric opening, e.g. rectangular or circular, is formed in the resin by photolithography. Those skilled in the art will recognize that the photolithography examples provided herein are mere examples of the mechanism for production of the described microscope slide with integrated filter material. Alternatively, one can also fuse (using optical glue) the color elements on a regular microscope slide. In any case the color filter array including each individual filter element comprises a structural modification relative to a remainder of the slide.

Although calibration accuracy would be greater if the color filter array were on the same slide as the test specimen, having a color filter array on each test-specimen slide would be cost-prohibitive. Additionally, due to magnification constraints, the color array 107 and the portion of the sample under investigation may not be resolvable in the same image. Accordingly, in a one arrangement, at least two slides are used for color calibration. The first slide contains the described integrated color array 107, while the second slide (not shown) contains a sample under investigation or analysis. FIG. 2 illustrates the slide substrate with an integrated color array 107 which is not configured with a sample on the same slide.

However, those skilled in the art will appreciate that the imaging device 102 is configurable to record an image of the slide 116 that captures both a sample and the color filter array 107. Furthermore, the slide 116 is optionally configured to incorporate additional enhancements capable of providing information to an end user. For example, the slide 116 incorporates visual source identifiers, such as serial numbers, bar codes, q-codes, or other visual identifiers.

In one arrangement of the filter array 107, the colors of the individual filter elements include typical colors (e.g. cyan, magenta, yellow, red, blue, and green) as well as colors that are specific to a particular procedure or outcome. In one arrangement filter elements directed to colors represented in Hematoxylin and Eosin stains used in routine diagnostic procedures are included in the color filter array. Those skilled in the art will recognize that additional filter elements are customizable at the time of manufacture to incorporate other color elements representing other diagnostic stains or colors.

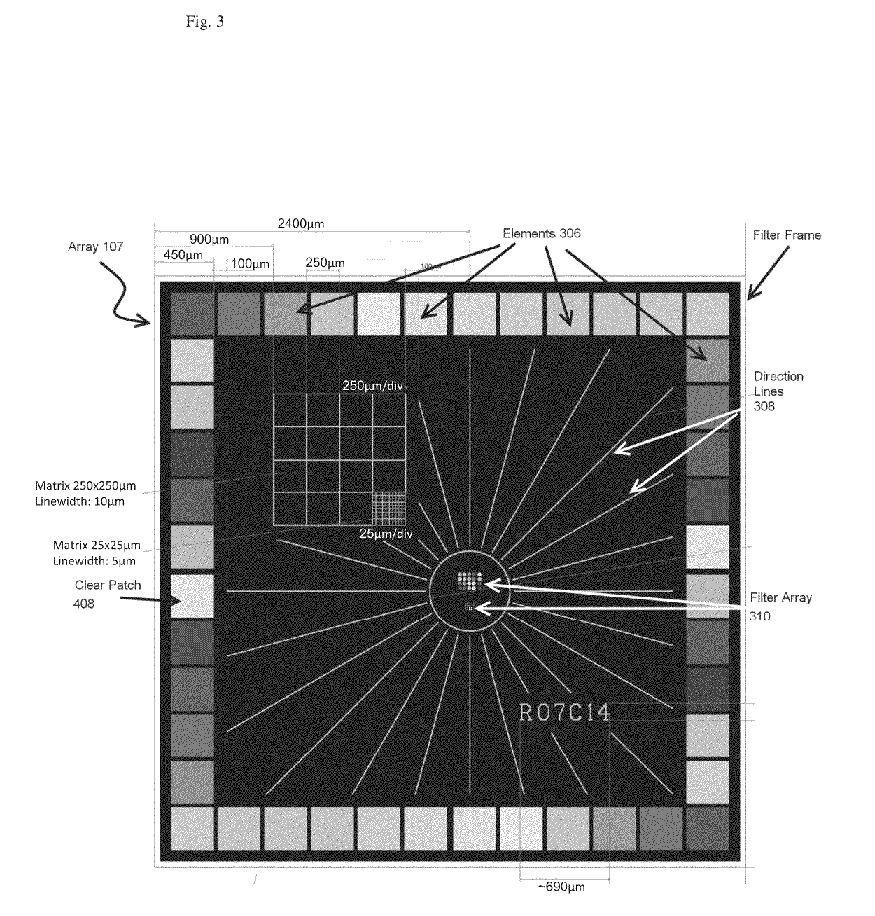

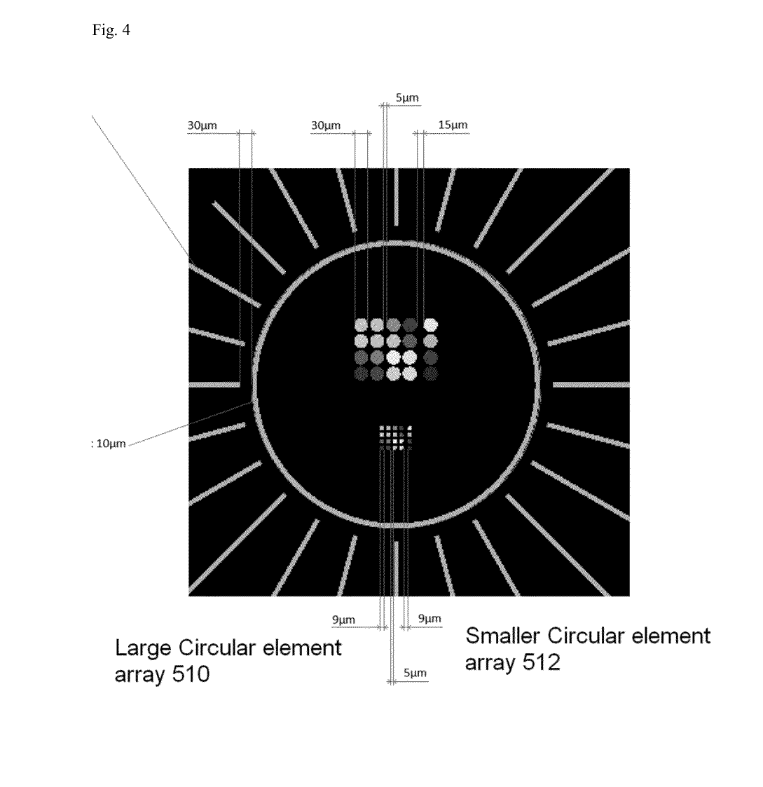

A more detailed view of the color filter array 107 is provided in FIG. 3. The filter elements are arranged and positioned on a filter frame 302. In one arrangement, the individual reference color elements color elements 306 are used for product quality control, or to calibrate an image of the entire slide, with no magnification. The filter arrays 310 are used to calibrate the colors when the sample is under magnification. As seen in FIG. 4, in one arrangement the large circular element array 510 is used for the magnification from 5× to 40×. The smaller circular element array 512 that is used for magnifications up to 100×.

In a particular arrangement, there are at least 16 color filter elements 306 included in the calibration. In this arrangement, the peak wavelengths and bandwidths of the 16 color patches are specifically designed to achieve the best color accuracy. Furthermore, the color filter elements do not largely overlap one another so as to provide a general filter spectrum for biological stains used in microscopy, not just Hematoxylin and Eosin. Those skilled in the art will recognize that more colors are needed for better color correction, and the usage will have greater applicability if the colors are not all H&E (Hematoxylin and Eosin) stains.

The microscope slide is configured to provide a user with a complete color calibration array at any magnification value up to 100×. In one arrangement, the dimension of the entire filter array is equal to or smaller than 65 μm in size on a side. Those skilled in the art will appreciate that any larger filter array, without modification or rearrangement, would present so many elements such that the entire color filter array would exceed the field of view of the microscope or fail to incorporate a sufficient number of individual filter elements.

Neutral filter elements are also incorporated into the color filter array integrated into the microscope slide. Inclusion of gray or other achromatic elements are used to provide a higher level of calibration accuracy than using color elements alone. In a further arrangement, the filter element includes a neutral color filter element.

In a further arrangement, the color filter array includes a clear patch element 408. The clear patch 408 allows for illumination to pass directly from the light source to the image capture device. This clear patch element assists in the subsequent color correcting and calibration processing by providing a basis for white balancing the image during image analysis.

By way of non-limiting example the color calibration slide described includes an integrated array of filter elements having a given dimension, each element further having a known transmission spectrum, wherein the complete filter array is observable in the field of view of a microscope under at least one magnification setting of the microscope.

In a further configuration, the filter array 107 also includes sub-filter arrays 410. When viewed under increased magnification, the sub-arrays 410 provide a user with a complete spectrum of color filter elements. In this arrangement, the number and spectrum of each element of the filter array is replicated as an element in the sub-filter array. In this arrangement, the color filter elements are maintained in terms of transmission and wavelengths, but the physical dimensions of the color filter elements are diminished. In a further arrangement, the sub-filter array 310 is calibrated to take into account changes in the numerical aperture setting from one objective setting to the next.

For example, the color calibration slide described includes at least one secondary or sub-filter array 310, the secondary filter array having at least one matching filter element for each element of the primary array. In a particular arrangement, the sub-filter array 310 incorporates elements which are of sufficient dimensions such that an entire filter array spectrum is viewable at magnifications from 10× to 100×.

In one arrangement, the filter or color elements of the sub-filter array 310 extend 26 microns along a side. In a further arrangement, the filter array 107 has a second sub-filter wherein each filter or color element extend 9 microns along a side.

The filter array 107 includes the use of direction or location lines 410 that allow a user, even under maximum magnification, to locate a particular color element location within the color matrix. Preferably, the line 410 are formed or applied in the same steps that define the color filter array and comprise structural elements that from the surrounding slide material.

As shown in FIG. 4, the sub-array filter elements are circular. Circular filter elements 502 allow for improved color consistency across filter elements and an easily reproducible manufacturing process at smaller scales.

In a further arrangement, each of the color elements regardless of position or dimensions have a peak light transmission of at least 40% and bandwidth of about 20-40 nm in order to achieve the desired signal-to-noise ratio. In one configuration, these characteristics are achieved through the use using interference-filter technology. For example, the characteristics of the interference-filter or dichroic filter are configured such that the filter elements have high-pass, low-pass, band-pass, or band-rejection filter properties, such as narrow band-pass filters and/or neutral density filters. Those skilled in the art will appreciate that any combination of filters that are suitable for the given illumination source 114 (e.g. incandescent, UV etc.) is envisioned.

The interference filters defined in the manner described above and used in the current invention are more resistant to environmental influences than the current art of plastic filters mounted to glass. Interference filter technology also allows narrow-band transmission that is efficient enough to satisfy the 40% criterion. Furthermore, the described filter elements have background transmissions of less than 0.1 percent, thereby achieving a low level of cross-talk between the filter channels.

Those skilled in the art will recognize that the color filter element so describe are structural elements. The properties of these structural elements, such as spectra transmission are not reproducible using pigments or paint applied to the slide substrate. Furthermore, the present filter array employs filter sizes of sufficient dimension to make it difficult or cost prohibitive to apply, pigmentation directly to the slide.

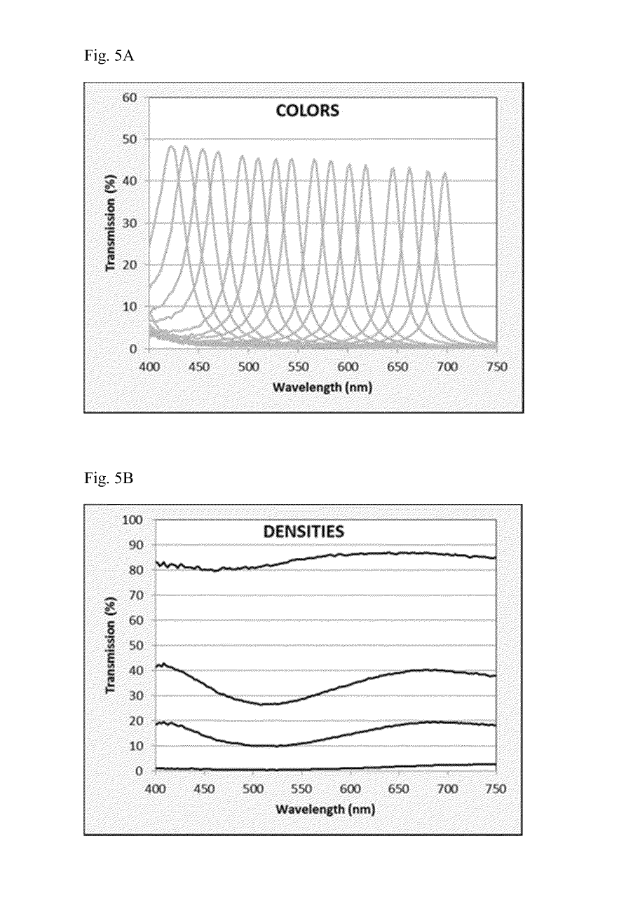

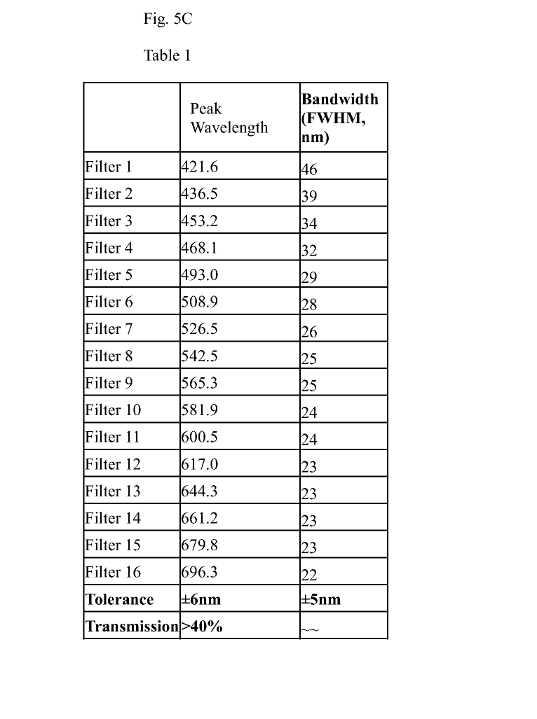

Each of the arrays depicted in FIGS. 2-4 provide a plurality of narrow-band color filters with peak wavelengths covering the visible spectrum (e.g., ranging from 400 to 700 nm) and neutral density filters with the given optical densities (OD) as provided in FIGS. 5A-B. Furthermore, as shown in Table 1 of FIG. 3C, the peak wavelength and bandwidth of each filter is pre-measured and/or known. The measurement of the transmission spectra is accomplished using industry standard techniques and instruments. Once the values of the elements of the array are known, they are stored in a database or look up table for future reference. Those skilled in the art will recognize interference filter and photolithography technology so described allows for minimal transmission variation across individual slide arrays. This allows for a consistent level of inter-instrument agreement across an organization and enables the production of substantially uniform calibration results. The small transmission variation is reflected from the small tolerance number shown in FIG. 5C.

Those skilled in the art will appreciate that the light spectra transmitted by the filter elements comprising the color filter array 107 may be sensitive to viewing and illumination angle. Thus, in one arrangement, the light transmission values of the color filter array 107 are recorded at several N.A. (numerical aperture) settings. These values are also stored within a database for future reference during the color calibration processing.

The microscope slide with integral filter array is used in a method for using a calibration slide with an integral color filter array configured with sub-filter arrays and guidelines comprising a step of obtaining an image of a sample slide affixed at a given microscope setting within a microscope. The method also allows for a step of, without changing microscope setting, withdrawing the sample slide and inserting the calibration slide with the integral color filter array. A further step is provided that includes locating a guideline of the filter array in the field of view of the microscope and moving the calibration slide along the guideline until a sub-array element is visible in the microscope field of view. Once the sub-filter array is located the method provides for obtaining an image of the sub-filter array and transmitting both the image of the sub-filter array and the image of the sample slide to an image processing appliance. For example, the microscope slide guidelines are configured to link at least one filter elements of the primary to at least one corresponding element of at least one secondary array. The guideline is also equipped to list one element of a secondary array to at least one corresponding element of a smaller additional array.

The slide 116 and integrated filter element so-described is configurable for use in a system and method for image analysis. For example images of the slide described, as a slide of a sample under investigator are recorded by the imaging device and transmitted as data to a processor 305, which is configured to generate the tri-stimulus values from the pixels of the images without human intervention. The processing duties and functions of the computer are, in one arrangement, performed by a local microprocessor configured to execute instructions stored in a storage medium. The local computer or processor 305 is further configured to possess a database in which reference data values are stored and accessed.

In an alternative arrangement, the computer 305 is part of a remote processing appliance accessible via a network. This reduces the need for complex computational hardware on site. In one arrangement, the specific calibration and maintenance issues are performed on a centrally located computer and software system. This configuration ensures minimal variance between users.

The computer 305 can optionally connect to external and internal networks so as to distribute processing tasks or exchange data related to each slide. For instance, the computer 305 can be configured to connect to networks and databases using commonly understood programming interfaces and interface modules, e.g., Media Server Pro, Java, Mysql, Apache, Ruby on Rails, and other similar application programming interfaces and database management solutions. The illustrated computer system 305 is characterized, in part, by its broad adaptability to user configurations, multiple user inputs, and hardware configurations.

The computer 305 is configured to allow a selection of a series of color correction options. For example, the computer 305 is configured to select one of a series of pre-defined destination illuminants for the resulting synthetic image. These destination illuminants (SPD vector), in part, configure the color values of the sample in the resulting synthetic image. For example, the destination illuminant selected is configured such that the resulting synthetic image matches the view of the sample as seen through the eyepiece of a microscope. In one example, the computer 305 provides access to a database which stores various pre-determined SPD vectors. Each stored SPD vector corresponds to a particular known lighting condition.

In the event that the light source 114 SPD vector (corresponding to the destination illuminant) is not stored in the database, that SPD must be pre-measured by a spectro-radiometer such as is made by Konica-Minolta CS-1000a, coupled to the eye piece 104 of the microscope and configured to output the SPD vector for use in the present system.

Those skilled in the art will appreciate that depending on the complexity of the calculations, adapted linear models or more complex mathematical models are used to determine the XYZ tristimulus values during the foregoing analysis.

The processor is configured by code executing therein to generate a CIE tristimulus vector of each filter element incorporating the real or ideal illuminant spectral power distribution values, known color filter transmission spectra values, and the 2° CIE color matching functions into a 3-by-K matrix, where K is the number of filter elements and the dimension 3 represents the X, Y, Z tristimulus coordinates. The given numerical aperture (N.A.) setting of the microscope determines which of the stored transmission spectra of each filter element is used.

The computer 305 is further configured by code executing therein to accept images of the slide that incorporate pixels corresponding to the color filter array 107 and the pixels corresponding to the sample 110. The computer 305 is further configured by code executing therein to generate a matrix of all the RGB pixel values from each filter k, such that the RGB vector is

$${D}_{k} = {( \begin{matrix}R \\ G \\ B\end{matrix} )}_{k} ,$$

where k is the number of color filters. The 3-by-K R, G, B matrix (D) corresponds to the pixel color values of the filter array. This matrix is mapped to tristimulus value matrix ( X̅) through the use of a 3 by 3 color mapping matrix (M) using the equation X̅=MD. Following the least-square approximation, M is estimated as M= X̅pinv(D)= X̅D′(DD′)⁻¹.

The database 306 is configured by code executing therein to store this color mapping matrix (M) for use with any subsequent test sample under the same illuminant with the same microscope settings.

Upon recording a raw image of the actual sample under study, the computer 305 is further configured by code executing therein transform the raw image to generate device-independent C.I.E. tristimulus values of each pixel on the image such that the pixels are transformed according to the following the equation of

$${( \begin{matrix}X \\ Y \\ Z\end{matrix} )}_{i , j} = {M ( \begin{matrix}R \\ G \\ B\end{matrix} )}_{i , j} ,$$

where i and j are the pixel coordinate of the real sample image.

The computer 305 is configured by code executing therein to output these corrected images as either a device independent C.I.E. value image or as an image of device-dependent RGB values for use with a color calibrated output device such as a monitor. For example, a calibrated monitor is provided with a display profile (e.g. a data file) that can be accessed by the processor to determine the proper display of RGB color values. The device independent C.I.E. value image is converted by sending the values through the proper display profile. Once converted through the display profile, the RGB values are configured by the processor by code executing therein for accurate display on the display device. Furthermore, a user is able to retrieve these images for further analysis or distribution.

The present invention also incorporates a sequence of steps for using the system so described to carry out and achieve the function of providing a color calibrated image to a display or storing the color calibrated image for later retrieval. Such a method involves, but is not limited to an instrument selection step, in which the settings, such as N.A., light source intensity, light source CCT, objective, and camera white balance and exposure time/gain, are set to the desired levels before the color correction procedure.

The method includes a calibrating step in which a spatial uniformity calculation is performed by the processor by code executing therein on a blank microscope field. A calculating step is performed by the processor by code executing therein in order to determine the CIE tristimulus values of the plurality of color filters comprising the color filter array using a real or ideal illuminant spectral power distribution, the known transmission spectra, and the 2° CIE color matching functions. An image recording step is also performed by the processor by code executing therein, in which an image of the color filter array is recorded and sent to a processor for processing. The method also provides for an extracting step in which the computer by code executing therein extracts the corresponding camera-RGB pixel values of each color filter to a matrix and maps that matrix to the CIE tristimulus value matrix of the color filters. A transformation step, also performed by the processor by code executing therein is provided in which the computer extracts the corresponding camera-RGB pixel values for the entire sample image and converts those values into corresponding device independent C.I.E. tristimulus values using the color mapping matrix.

The method also includes a step for generating device dependent RGB images which is also performed by the processor by code executing therein, for delivery to a calibrated monitor or printer. The present method can provide an optimization step, by code executing in a processor, for increased accuracy through the use of extended size matrices. In a further arrangement, the present method also includes an optional step of determining the spectral power distribution of the current illuminant through the use of a spectrophotometer or colorimeter.

Each of the steps described are performed and executed as a series of modules operating on a computer. Each of these modules can comprise hardware, code executing in a processor, or both, that configures a machine such as the computing system 305 to implement the functionality described herein. The functionality of these modules can be combined or further separated, as understood by persons of ordinary skill in the art, in analogous implementations of embodiments of the invention.

The calibration module is further configured to include a series of sub modules for recording the microscope and digital imager settings, including the numerical aperture values, and image settings. Furthermore, a sub-module is provided for recording an image of a blank microscope field and storing the resulting pixels intensities as Iₒ(i,j,b). In this module, i, j denote the spatial position of a pixel and b denotes the spectral band within the digital imaging device. A normalizing sub-module is provided for dividing any subsequent image pixels Iₙ(i,j,b) by the respective blank-field values Iₒ(i,j,b) to generate a normalized pixel value for use in the color calibration or in color rendering modules.

The color selection step includes a sub-module for allowing a user to select a specific destination illumination of the resulting synthetic image. The destination illumination spectrum is determined according to the illumination spectrum desired for the synthetic image. The user may select a pre-defined illuminant to render the image, in which case the software retrieves one of the SPD vectors (S) for known or common illuminants that have been pre-stored in the database accessible by the computer. Alternatively, the user may activate a sub-module configured to record the light-spectrum values from a spectroradiometer positioned in place of the eyepiece.

The calculating step includes a sub-module for obtaining the CIE tristimulus values of the color filters. In one particular instance, the instruction set uses specific algorithms to calculate the CIE-value vector

$$( \overline{{X}_{k}} = {( \begin{matrix}X \\ Y \\ Z\end{matrix} )}_{k} )$$

of each color filter by the following equations:

$$\begin{matrix}{X}_{k} = {k}_{0} {\sum }_{360 nm}^{780 nm} {T}_{NA} ( λ , k ) S ( λ ) \overline{x} ( λ ) Δ λ & ( Formula 1.0 ) \\ {Y}_{k} = {k}_{0} {\sum }_{360 nm}^{780 nm} {T}_{NA} ( λ , k ) S ( λ ) \overline{y} ( λ ) Δ λ & ( Formula 1.1 ) \\ {Z}_{k} = {k}_{0} {\sum }_{360 nm}^{780 nm} {T}_{NA} ( λ , k ) S ( λ ) \overline{z} ( λ ) Δ λ \\ With & ( Formula 1.2 ) \\ {k}_{0} = 100 / {\sum }_{360 nm}^{780 nm} S ( λ ) \overline{y} ( λ ) Δ λ & ( Formula 1.3 )\end{matrix}$$

Where T_{NA}(λ, k) is the transmission spectrum of the color filter at a specific numerical aperture (NA). The T_{NA}(λ, k) of each color filter is calibrated prior the color correction and saved in a storage, such as a database connected to the computer 305. S(λ) is the spectral power distribution (SPD) of the either a standard illuminant, such as D65, A, and F11, or the actual SPD of the microscope light source.

In the above formulas, x(λ),y(λ),z(λ) are 2° CIE color matching functions. The C.I.E. tristimulus values of all the color filters are combined into a 3 by K matrix ( X̅), where K is the number of color filters and 3 refers to the X, Y, Z values.

The calculating module also includes a sub-module for generating a matrix from the RGB pixel values of the color filter array such that a 3 by K matrix (D), where the k^{th} column of D

$$( {D}_{k} = {( \begin{matrix}R \\ G \\ B\end{matrix} )}_{k} )$$

represents the spatial average of the pixels from filter color k. An additional sub-module is provided to map the D matrix to C.I.E. tristimulus values ( X̅) matrix through a 3 by 3 color mapping matrix (M) using the equation X̅=MD. Following the least-square approximation, M is estimated as M= X̅pinv(D)= X̅D′(DD′)⁻¹.

The optimization module also includes a sub-module for extending the linear 3 by 3 matrix to larger matrices in order to yield improved accuracy. In one example, the vectors Dₖ is extended from [R G B]ₖ′ to [R G B R² G² B² RG RB GB]ₖ′. As a result, the matrix D is extended from 3 by K to 9 by K, and the color mapping matrix (M) is extended from 3 by 3 to 3 by 9. This provides better color accuracy at the cost of less tolerance to the nonlinearity of the camera response. In the alternative, the sub module is equipped to extend the linear 3 by 3 matrix into larger matrices by extending vector Dₖ from [R G B]ₖ′ to [R G B (RG)^{1/2} (BG)^{1/2} (RB)^{1/2} . . . ]ₖ′.

An additional sub-module is directed to transforming the RGB values on each pixel of the sample image so as to match anticipated color values under the destination illuminant. For example, the transformation sub-module is configured to transform the pixels according to the following the equation

$${( \begin{matrix}X \\ Y \\ Z\end{matrix} )}_{i , j} = {M ( \begin{matrix}R \\ G \\ B\end{matrix} )}_{i , j} ,$$

where i and j are the pixel coordinate of the sample image. A further sub-module is provided to store the resulting XYZ C.I.E. tristimulus values in a database. Thus, the color calibration matrix M, derived from the tristimulus values of the array, is used to transform the RGB values of the image pixels of the test image to generate a device independent image.

A display module is provided that processes the XYZ values through a display profile, thus creating a device-dependent image of display-RGB inputs to drive a calibrated display device, such as a monitor.

In one particular configuration the invention also includes a computer implemented method for obtaining an image of a calibration slide having an integral color filter array configured with sub-filter arrays and guidelines comprising the steps of automatically obtaining an image of a sample slide affixed at a given microscope setting within a microscope. The described method also includes automatically withdrawing the sample slide, such as with an automated slide extraction mechanism and inserting the calibration slide having with the integral color filter array.

A further step in the described method includes optionally locating a guideline of the filter array in the field of view of the microscope using an optical tracking device. For example, a camera or sensor configured to optically scan or evaluate an image of the guidelines. In one configuration, the guidelines are applied, painted or coated with a material having a particular optical characteristic such as fluorescence or a specific spectral luminescence.

The computer implemented method also includes automatically moving the calibration, such as with computer controlled slide positioning device, along the guideline until a sub-array element is visible in the microscope field of view. Furthermore steps for obtaining an image of the sub-filter array and transmitting both the image of the sub-filter array and the image of the sample slide to an image processing appliance are provided.

It should be understood that various combination, alternatives and modifications of the present invention could be devised by those skilled in the art. The present invention is intended to embrace all such alternatives, modifications and variances that fall within the scope of the appended claims.

While the invention has been particularly shown and described with reference to a preferred embodiment thereof, it will be understood by those skilled in the art that various changes in form and details may be made therein without departing from the spirit and scope of the invention.

What is claimed:

1. A color calibration microscope slide having:
a primary integrated array of filter elements of a given dimension, each element having a known transmission spectrum, wherein the filter array includes at least one secondary filter array,
wherein the secondary filter array includes a corresponding filter element for each filter element in the primary integral filter array, at a smaller dimension.

2. The color calibration microscope slide with integral filter array elements as in claim 1,
wherein at least one complete filter array is observable in the field of view of a microscope under a given magnification setting of a microscope.

3. The microscope slide with integral filter array elements as in claim 1,
wherein the transmission spectra value for each element of the secondary filter array corresponds to a calibrated transmission spectra value for a corresponding element of the primary integrated array.

4. The microscope slide with integral filter array elements as in claim 1,
wherein the calibration of the transmission spectra value is based on the change in numerical aperture.

5. The microscope slide with integral filter array as in claim 1, wherein the sub-array filter elements are circular in shape.

6. The microscope slide with integral filter array as in claim 1, wherein at least one element of the primary filter array is lacking any filter element.

7. The microscope slide with integral filter array as in claim 1, wherein the filter elements of the at least one sub-array are no larger than 9-microns on a side in dimension.

8. The microscope slide with integral filter array as in claim 1, wherein the filter elements of the at least one sub-array are no larger than 26-microns on a side.

9. The microscope slide with integral filter array as in claim 1,
wherein the filter array includes guide lines to direct a user to a sub-filter array.

10. The microscope slide with integral filter array as in claim 1,
wherein the filter array includes a background configured to minimize stray light.

11. The microscope slide with integral filter array as in claim 1,
wherein the filter array includes an integrated grid for scale measurement using elements of known dimension.

12. A method for using a calibration slide having an integral color filter array configured guidelines comprising:
obtaining an image of a sample slide affixed at a given microscope setting within a microscope;
without changing any microscope setting, withdrawing the sample slide and inserting the calibration slide having with the integral color filter array;
locating a guideline of the filter array in the field of view of the microscope;
moving the calibration slide along the guideline until the filter array is visible in the microscope field of view;
obtaining an image of the filter array; and
transmitting both the image of the filter array and the image of the sample slide to an image processing appliance.

13. A method for using a calibration slide having the integral color filter array of claim 12 wherein:
the color filter array configured with at least one additional sub-filter array configured to be completely observable at a higher magnification setting.

14. A method for using a calibration slide having the integral color filter array of claim 13 wherein:
the sample and integral array are on a separate microscope slides.

15. A method for using a calibration slide having the integral color filter array of claim 12, wherein the color correction includes further step of:
converting the tristimulus image output through the use of a RGB device dependent profile; and
generating a RGB corrected image.

16. A method for using a calibration slide having the integral color filter array of claim 12, wherein the array image and the test image are selections taken from different images.

17. A color calibration microscope slide having:
a primary integrated array of filter elements having a given dimension, each element further having a known transmission spectrum, wherein the complete filter array is observable in the field of view of a microscope under at least one magnification setting of the microscope.

18. A microscope slide of claim 17:
wherein the integrated filter array has at least one secondary filter array, the secondary filter array having at least one matching filter element for each element of the primary array, the microscope slide further equipped with guidelines between the filter elements of the primary array and the at least one corresponding element of the secondary array.

19. A microscope slide of claim 17:
wherein at least one complete filter array is observable at a 100× magnification setting on a microscope.

20. A microscope slide of claim 17:
wherein the microscope slide includes at least one complete filter array that is observable at 20× magnification and at least one complete filter array that is observable at a second higher magnification setting on a microscope.
